(19) United States
(12) Patent Application Publication
(10) Pub. No.: US 2016/0249647 A1
(43) Pub. Date: Sep. 1, 2016

(54) PROCESS FOR LASER ETCHING A PATTERN ON A SANDWICH ROLL OR BUN

(71) Applicant: MECANIQUE SYSTEMES, Gignac-la-Nerthe (FR)

(72) Inventor: Xavier CUNY, Velaux (FR)

(21) Appl. No.: 14/901,055

(22) PCT Filed: Jun. 27, 2014
(86) PCT No.: PCT/FR2014/051654

§ 371 Date: Apr. 26, 2016

(30) Foreign Application Priority Data
Jul. 3, 2013 (FR) 1356495

(51) Int. Cl. A23L 1/025; A21C 15/00

(52) U.S. Cl. CPC A23L 1/0073; A23P 1/10; A21C 15/00; A23V 2002/00

(57) ABSTRACT

Process for etching a pattern on a surface (S) of a sandwich roll or bun (P) after the roll or bun (P) has been baked, by applying to the surface of the roll or bun (P) a laser beam emitted from an etching unit (2) equipped with a laser source (20), said process implementing the following steps: focusing the laser beam output from the etching unit (2) with an adjustable focal length between the exit of the etching unit (2) and a focal point (PF) of the laser beam; adjusting the focal length of the laser beam so that the surface (S) of the roll or bun (P) to be etched does not coincide with the focal point (PF); passing the laser beam over the surface (S) of the roll or bun (P) to be etched in order to produce the etch lines of the pattern, with a plurality of passes of the laser beam over each etch line; and placing the roll or bun (P) in a sealed package after etching.

### TECHNICAL FIELD

The present invention relates to a method for engraving a pattern on a hamburger bread or <<buns<< bread.

It relates more particularly to an engraving method by applying on the surface of the hamburger bread a laser beam emitted from an engraving unit equipped with a laser source.

### BACKGROUND

It is known, in particular from the documents US2011/012986 DE102006037922, EP1747838, DE19730887, FR2652541 and DE3803261, to proceed to a laser engraving of a pattern on a food item like fish, meat, fruit, vegetable, pork product, cheese, bread, pastry or cake.

Such methods generally implement a laser source and a system for guiding and focusing the laser beam to carry out the engraving of the desired pattern on the surface of the food item.

However, the laser engraving methods disclosed in these documents are inefficient for engraving in a sustainable manner a pattern on an industrially produced and packaged buns-type bread or hamburger bread.

Indeed, with a hamburger bread (otherwise called <<buns<<), it is observed that the engraved pattern is tending to disappear once the bread is packaged in a sealed manner, under the effect of the yeast which, even after baking of the dough, slightly continues its fermentation process. In a sealed packaging, it is observed that the particular humidity and temperature conditions inside the packaging help the yeast to continue to interact with the organic compounds present in the dough which thus continues to rise, slightly certainly but enough to degrade even eliminate the pattern engraved on the surface of the bread.

Thus, when engraving the hamburger breads after baking according to the conventional techniques, then packaging the breads within sealed packaging, the atmosphere inside the packaging proves to be sufficiently wet for the fermentation to continue slightly and makes the engraved pattern, at least in part, disappear. Moreover, it is to be noted that, in the particular case of packaged hamburger breads, this continuation of fermentation contributes to rebalance the colors (in other words a color standardization) of the external surface (or crust) of the bread. Furthermore, for the industrially produced hamburger breads, it is crucial to proceed to a quick packaging after baking in order to prevent them from drying and thus maintain the softness of the breads.

### BRIEF SUMMARY

The present invention aims to provide an engraving method which allows engraving perennially a pattern on a hamburger bread, after baking of the bread and prior to its sealed packaging, without the fermentation phenomenon, which continues slightly in the packaging, making the engraved pattern disappear.

To this end, it provides a method for engraving a pattern on a surface of a hamburger bread or <thuns bread, after baking the bread, by applying on the surface of the bread a laser beam emitted from an engraving unit equipped with a laser source, said method implementing the following steps:

focusing the laser beam at the outlet of the engraving unit, with an adjustable focal distance between the outlet of the engraving unit and a focal point of the laser beam;

adjusting the focal distance of the laser beam so that the surface of the bread to be engraved does not match with the focal point;

passing the laser beam on the surface of the bread to be engraved to carry out the engraving lines of the pattern, with several passes of the laser beam on each engraving line;

packaging in a sealed manner the bread after engraving.

This combination of steps contributes to obtaining a lasting engraving of a pattern on the surface of the hamburger bread, which forms a definitive mark which does not disappear under the effect of the yeast which slightly continues its fermentation within the sealed packaging. By multiplying the number of passes of the laser beam, it is guaranteed an engraving (by burning the bread crust) sufficiently deep and dark to get a visible pattern which lasts. Since the number of passes of the laser beam is multiplied, the laser beam is not focused on the surface of the bread to be engraved (in other words the surface to be engraved is located above or below the focal point, in a defocused zone of the laser beam) so as to prevent the laser beam from cutting the bread due to the successive passages.

Thus, thanks to the invention, the packaging does not lead to the disappearance of the engraved pattern, even though the atmosphere in the packaging contributes to the continuation of the fermentation phenomenon, in particular with the rebalancing phenomenon of the crust colors.

In a particular embodiment, the engraving of the pattern is carried out on the bread before the fermentation is completely finished.

In accordance with other advantageous features of the invention:

a power of the laser source is selected between 10 and 400 watts, preferably between 10 and 250 watts, and more preferably between 30 and 150 watts;

the displacement speed of the laser beam on the surface of the bread is driven between 10 and 40,000 millimeters per second, preferably between 10 and 18,000 millimeters per second, and more preferably between 100 and 12,000 millimeters per second;

the focal distance is adjusted between 50 and 1,500 millimeters, preferably between 50 and 1,200 millimeters, and more preferably between 80 and 900 millimeters;

the number of passes of the laser beam on each engraving line of the pattern is comprised between 10 and 300 passes, preferably between 10 and 60 passes;

the laser beam is applied on the surface of the bread during a period comprised between 0.2 and 20 seconds;

the focal distance of the laser beam is adjusted so that the surface of the bread to be engraved is located at a distance from the engraving unit comprised between 0.8 and 1.2 times the focal distance;

the focal distance of the laser beam is adjusted so that the surface of the bread to be engraved is located at a distance from the engraving unit not comprised between 0.95 and 1.05 times the focal distance.

The invention also relates to an installation for engraving a pattern on a surface of a hamburger bread or “buns” bread, after baking the bread, said installation comprising an engraving unit equipped with a laser source, said engraving unit comprising a means for adjusting the focal distance of the laser beam between the outlet of the engraving unit and a focal point of the laser beam, and a means for adjusting the number of passes of the laser beam on each engraving line of the pattern, and further comprising a unit for packaging in a sealed manner the bread, disposed after the engraving unit.

### BRIEF DESCRIPTION OF THE DRAWINGS

Other features and advantages of the present invention will appear on reading the detailed description hereinafter, of a non-limiting example of implementation, with reference to the following appended figures:

FIG. 1 illustrates schematically an engraving installation in accordance with the invention; and

FIG. 2 which corresponds to a zoom on the zone II of FIG. 1.

### DETAILED DESCRIPTION

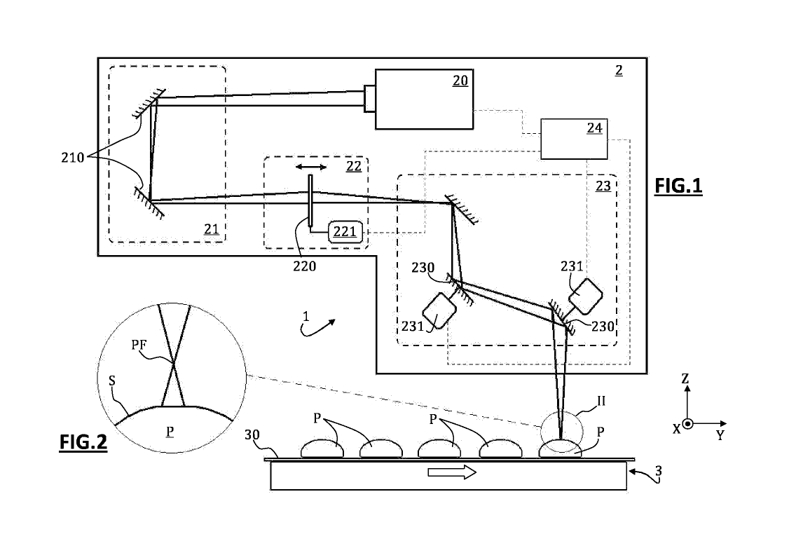

With reference to FIG. 1, the engraving installation 1 includes:

a laser engraving unit 2;

a unit 3 for conveying hamburger breads P, having an upper or external surface S forming the golden crust of the bread; and

a unit (not illustrated) for packaging in a sealed manner the breads, disposed after the engraving unit 2, the breads P being conveyed from the engraving unit 2 to the packaging unit by means of the conveying unit 3.

The engraving unit 2 is positioned after the breads P baking oven (not illustrated), even after a unit (not illustrated) for cooling the breads designed to cool the breads A at the outlet of the oven, and in particular for bringing the temperature of the breads A at the room temperature.

The engraving unit 2 includes successively:

a laser source 20 of the carbon dioxide laser type emitting a laser beam;

a system 21 of 180° deflection of the laser beam, integrating mirrors and/or lenses 210 which return by 180° the orientation of the laser beam;

a motorized system 22 for adjusting the focal distance of the laser beam at the outlet of the engraving unit 2, this motorized system 22 comprising a lens 220 driven in translation by a motor 221;

a galvanometric head 23 comprising two mirrors 230 redirecting the laser beam along two axes X, Y, these two mirrors 230 being driven in position by respective motors 231;

a control unit 24 controlling both the laser source 20, the motor 221 of the motorized system 22 and the motors 231 of the galvanometric head 23.

The conveying unit 3 includes a belt extending along a horizontal plane parallel to the axes X, Y, on which the breads P are linearly conveyed.

At the outlet of the engraving unit 2, in other words at the outlet of the galvanometric head 23, the laser beam extends along a vertical axis Z, perpendicular to the conveyor belt 30.

The implementation of the method for engraving a pattern (text and/or drawing) is carried out with the following six constraints or conditions.

The first constraint concerns the power of the laser source 20 which is comprised between 10 and 400 watts, and in particular between 30 and 150 watts, as for example in the order of 100 watts.

Thus, the power of the laser source 20 is at least 10 watts if the engraving unit 2 is very close to the bread P working with a short focal distance, but may range up to 400 watts. When engraving the pattern, the control unit 24 can drive the laser source 20 to vary the power depending on the engraving line of the pattern (the engraved pattern comprising a plurality of straight or curved engraving lines), because the strokes or lines of the pattern may require different powers because any particular line must be more or less pronounced in the pattern.

The second constraint concerns the displacement speed of the laser beam on the surface of the bread P which is comprised between 10 and 40,000 millimeters per second. This displacement speed, or engraving speed, is directly given by the frequency of the laser source 20 and the displacement speed of the mirrors 230 driven by the motors 231 of the galvanometric head 23. The frequency of the laser source 20 is a parameter intrinsic to the source and this frequency is advantageously set between 1 and 20 kHz in order to obtain a satisfactory and lasting engraving. Furthermore, the control unit 24 can drive the motors 231, and thus control the speeds of the mirrors 230 and thus the displacement speed of the laser beam in the plane X, Y to vary the speed depending on the shape and the dimensions of the pattern to be engraved. By way of example, the displacement speed may decrease with the diameter of a circle to be engraved. For an aerated white bread, such as a buns-type bread or hamburger bread, the displacement speed is advantageously comprised between 10 and 18,000 millimeters per second, preferably between 100 and 12,000 millimeters per second, as for example in the order of 10,000 millimeters per second.

The third constraint concerns the focal distance of the laser beam at the outlet of the engraving unit 2 (along the vertical axis Z) which is comprised between 50 and 1,500 millimeters; this focal distance being adjusted by the motorized system 22. The focal distance corresponds to the distance between the outlet of the galvanometric head 23 and the focal point PF of the laser beam (virtual point of convergence on which the beam is most concentrated, and which actually corresponds to a non-point convergence zone). It should be noted that the focal distance is related to the laser power, resulting in a relationship between the focal distance and power which allows optimizing power and the thermal effect on the bread P and thus optimizing the period of engraving. This focal distance is advantageously comprised between 50 and 1,200 millimeters, preferably between 80 and 900 millimeters as for example in the order of 800 millimeters.

The fourth constraint concerns the adjustment of the focal distance of the laser beam at the outlet of the engraving unit 2 so that the surface S of the bread P is positioned at a distance from the engraving unit 2 (or distance relative to the outlet of the galvanometric head 23) comprised between 0.8 and 1.2 times the focal distance, while ensuring that the surface S of the bread P to be engraved does not match with the focal point PF, as illustrated in FIG. 2; this adjustment depending of course on the distance between the surface S of the breads P and the outlet of the engraving unit 2. In other words, as visible in FIG. 2, the surface S of the bread P to be engraved is not exactly positioned on the focal point PF of the laser beam, to prevent a laser cutting instead of an engraving, but in a zone around this focal point, within a range of more or less 20% of the focal distance around the focal point PF. It is then about a defocusing which allows using the thermal effect of the laser beam, without cutting the bread P. Advantageously we choose to adjust the focal distance so that the surface S of the bread P to be engraved is not located at a distance from the engraving unit 2 comprised between 0.95 and 1.05 times the focal distance. To summarize, the surface S of the bread P is located at a distance from the engraving unit 2 comprised between 0.8 and 0.95 times the focal distance or at a distance comprised between 1.05 and 1.2 times the focal distance. This distance will of course have an influence on the thickness of the stroke because the closer to the focal point the finer the stroke, and the farther the focal point the thicker the stroke. By way of example, for a focal distance of 800 millimeters, the surface of the bread P to be engraved is located at a distance from the outlet of the galvanometric head 23 comprised between 640 and 760 millimeters or between 840 and 960 millimeters.

The fifth constraint concerns the period of engraving which is comprised between 0.2 and 20 seconds; this period of engraving being directly related to the dimensions of the pattern and to the lengths of its lines. The control unit 24 controls the laser source 20 to adjust this period of engraving.

The sixth constraint concerns the number of passes of the laser beam on each of the lines of the pattern to be engraved on the surface of the bread P which is comprised between 10 and 300 passes. In order to create an optimal thermal effect of the laser engraving, the same line or outline of the pattern is the subject of several passages of the laser beam, this number of passes being optimized in order to lastingly mark the surface with a fine and accurate marking, without digging or damaging the bread P. The control unit 24 controls the laser source 20 to adjust the number of passes.

Of course the example of implementation mentioned above has no limiting character and other improvements and details may be provided to the installation according of the invention, without departing from the scope of the invention where other means for controlling the laser beam and/or means for conveying food items may be for example carried out.

1. A method for engraving a pattern on a surface of a hamburger bread or <<buns<< bread, after baking the bread, by applying on the surface of the bread a laser beam emitted from an engraving unit equipped with a laser source, said method implementing the following steps:
focusing the laser beam at the outlet of the engraving unit, with an adjustable focal distance between the outlet of the engraving unit and a focal point of the laser beam;
adjusting the focal distance of the laser beam so that the surface of the bread to be engraved does not match with the focal point;
passing the laser beam on the surface of the bread to be engraved to carry out the engraving lines of the pattern, with several passes of the laser beam on each engraving line;
packaging in a sealed manner the bread after engraving.

2. The engraving method according to claim 1, wherein the engraving of the pattern is carried out on the bread before the fermentation of the bread yeast is completely finished.

3. The engraving method according to claim 1, wherein a power of the laser source is selected between 10 and 400 watts.

4. The engraving method according to claim 1, wherein the displacement speed of the laser beam on the surface of the bread is driven between 10 and 40,000 millimeters per second.

5. The engraving method according to claim 1, wherein the focal distance is adjusted between 50 and 1500 millimeters.

6. The engraving method according to claim 1, wherein the number of passes of the laser beam on each engraving line of the pattern is comprised between 10 and 300 passes.

7. The engraving method according to claim 1, wherein the laser beam is applied on the surface of the bread during a period comprised between 0.2 and 20 seconds.

8. The engraving method according to claim 1, wherein the focal distance of the laser beam is adjusted so that the surface of the bread to be engraved is located at a distance from the engraving unit comprised between 0.8 and 1.2 times the focal distance.

9. The engraving method according to claim 1, wherein the focal distance of the laser beam is adjusted so that the surface of the bread to be engraved is located at a distance from the engraving unit not comprised between 0.95 and 1.05 times the focal distance.

10. An installation for engraving a pattern on a surface of a hamburger bread or <<buns<< bread, after baking the bread, said installation comprising an engraving unit equipped with a laser source, said engraving unit comprising a means for adjusting the focal distance of the laser beam between the outlet of the engraving unit and a focal point of the laser beam, and a means for adjusting the number of passes of the laser beam on each engraving line of the pattern, and further comprising a unit for packaging in a sealed manner the bread, disposed after the engraving unit.
